(19) United States
(12) Patent Application Publication
(10) Pub. No.: US 2013/0292004 A1
(43) Pub. Date: Nov. 7, 2013

(54) DEVICES AND METHODS FOR AUTOMATICALLY RECONSTITUTING A DRUG

(71) Applicants: Maurice Ducret, Burgdorf (CH); Jean-Noel Fehr, Neuenburg (CH); Walter Fuerst, Burgdorf (CH); Sofia Galbraith, Solothurn (CH); Joerg Luemkemann, Loerrach (DE); Marcel Mueller, Therwil (CH); Urs Rindlisbacher, Thoerishaus (CH); Simon Scheurer, Bern (CH); Oliver Shergold, Bolligen (CH)

(72) Inventors: Maurice Ducret, Burgdorf (CH); Jean-Noel Fehr, Neuenburg (CH); Walter Fuerst, Burgdorf (CH); Sofia Galbraith, Solothurn (CH); Joerg Luemkemann, Loerrach (DE); Marcel Mueller, Therwil (CH); Urs Rindlisbacher, Thoerishaus (CH); Simon Scheurer, Bern (CH); Oliver Shergold, Bolligen (CH)

(73) Assignee: F. HOFFMANN-LA ROCHE AG, Basel (CH)

(21) Appl. No.: 13/813,730

(22) PCT Filed: Aug. 10, 2010
(86) PCT No.: PCT/EP2010/061643

§ 371 Date: Jul. 9, 2013

(51) Int. Cl. A61J 1/20

(52) U.S. Cl. CPC A61J 1/20
USPC 141/351

(57) ABSTRACT

Devices and methods are disclosed which automatically reconstitute a drug, such as e.g., a lyophilized drug. A vial (30) containing the drug is fluidly coupled to a cartridge (12) containing a reconstitution liquid with a fluid conduit (14f), wherein an entry point is defined where the fluid conduit enters the vial (30). The device (10) automatically adjusts orientation of the vial (30) such that the entry point of the vial is gravitationally higher than the drug in the vial (30), and automatically transfers the reconstitution liquid out of the cartridge (12) and into the vial (30) to create a reconstituted drug. The device (10) also automatically adjusts the orientation of the vial (30) such that the entry point of the vial is gravitationally lower than the reconstituted drug, and automatically transfers the reconstituted drug from the vial (30) and into the cartridge (12).

### TECHNICAL FIELD

The present disclosure generally relates to devices and methods for automatically reconstituting a drug, or multiple drugs that require diluting and/or mixing.

### BACKGROUND

As background, certain drugs may not be stable in a liquid solution for long-term storage, or must be diluted from a more stable concentrated liquid form prior to administration (collectively “reconstitution”). For example, in some instances drug solutions are lyophilized into a powdered form using a freeze-dry or other similar process. A lyophilized drug may then be suitable for long-term storage and may be converted back into a liquid form when it is ready to be used. Furthermore, some combinations of drugs are not stable long-term and must be combined a short time prior to administration.

Reconstitution of a drug or combination of drugs for administration such as reconstitution of a lyophilized drug from its powdered state to a liquid state may require a number of steps such as, for example, mixing the drug with a predetermined amount of a reconstitution liquid (e.g., water) and waiting a minimum time period to allow the reconstitution process to fully complete. It may be beneficial for a device to automate the reconstitution process for ease of use and to reduce the possibility of human error. Furthermore, automated preparation of a drug or drug combination can reduce the risk of exposure to highly toxic or mutagenic substances such as are utilized for chemotherapy. Also, during the reconstitution process, it may be beneficial to prevent the formation of air bubbles in the reconstituted drug. Thus, devices and methods are needed which automatically reconstitute a lyophilized drug while minimizing or eliminating the introduction of air bubbles into the reconstituted drug, as well enabling the process to take under laminar flow conditions without the presence of the operator.

### SUMMARY

In one embodiment, a device which automatically reconstitutes a drug is disclosed. The device comprises a cartridge which contains a liquid capable of reconstituting the drug; a vial containing the drug; a connector providing a fluid conduit and to which the vial containing the drug removably inserts, said fluid conduit fluidly couples the cartridge to the vial and defines an entry point where the fluid conduit enters the vial when inserted into the connector; a cartridge drive mechanically coupled to the cartridge and which changes a pressure of fluid in the cartridge to transfer fluid into or out of the cartridge through the fluid conduit; a vial drive which adjusts an orientation of the vial; and a controller electrically coupled to the cartridge drive and the vial drive such that the controller controls transfer of fluid into or out of the cartridge by activating the cartridge drive and controls the orientation of the vial by activating the vial drive.

In another embodiment, a method for automatically reconstituting a drug is disclosed. The method comprises fluidly coupling a vial containing the drug to a cartridge containing a liquid with a fluid conduit, wherein an entry point is defined where the fluid conduit enters the vial; automatically adjusting an orientation of the vial such that the entry point of the vial is gravitationally higher than the drug in the vial; automatically transferring the liquid out of the cartridge and into the vial to create a reconstituted drug; automatically adjusting the orientation of the vial such that the entry point of the vial is gravitationally lower than the reconstituted drug; and automatically transferring the reconstituted drug from the vial and into the cartridge.

In another embodiment, a method for automatically reconstituting and delivering a drug to a user which comprises utilizing the above mentioned device is also disclosed.

These and other advantages and novel features of the invention will become apparent from the following detailed description of the invention when considered in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference characters and in which:

FIG. 1 depicts a top perspective view of a device for automatically reconstituting a drug according to one or more embodiments shown and described herein;

FIG. 2 depicts a partial section view, taken along section line 2-2 of the device of FIG. 1, according to one or more embodiments shown and described herein;

FIG. 3A depicts a side view of a cartridge shown in cross section, a cartridge drive shown in cross section, a connector shown in cross section, and a vial drive according to one or more embodiments shown and described herein;

FIG. 3B depicts an end view of a cartridge, a cartridge drive, a connector, and a vial drive according to one or more embodiments shown and described herein;

FIGS. 4A and 4B depict section views of a connector and a vial according to one or more embodiments shown and described herein;

FIG. 5 depicts a close-up, section view of the device of FIG. 2 transferring the liquid from the cartridge and into the vial according to one or more embodiments shown and described herein;

FIG. 6 depicts a close-up, section side view of the device of FIG. 2 transferring the reconstituted drug from the vial and into the cartridge according to one or more embodiments shown and described herein;

FIG. 7 depicts a front side view of the device of FIG. 1 and illustrating agitation of the reconstituted drug in the vial according to one or more embodiments shown and described herein;

FIG. 8 depicts a schematic view of a device for automatically reconstituting a drug according to one or more embodiments shown and described herein;

FIG. 9 depicts a flow chart of a method for automatically reconstituting a drug according to one or more embodiments shown and described herein;

FIG. 10 depicts a simplified fluid conduit between a vial and a cartridge according to one or more embodiments shown and described herein; and

FIGS. 11A-G depict an in-line system as well as a method for automatically reconstituting a drug according to one or more embodiments shown and described herein.

### DETAILED DESCRIPTION

The embodiments described herein generally relate to devices and methods for automatically reconstituting a drug, or multiple drugs that require diluting and/or mixing.

For purposes of this disclosure, reconstitution refers to any of and combinations of conversion of a drug in a solid or semi-solid form into a liquid form suitable for administration to an animal by infusion or injection, conversion of a concentrated liquid form of a drug into a diluted liquid form suitable for administration to an animal by infusion or injection, or to preparing a liquid mixture of two or more drugs (each of which can initially be provided in any of a solid, a semi-solid or a liquid form) suitable for administration to an animal by infusion or injection. Thus, a reconstituted drug is any liquid drug formulation formed from any combination of one or more drugs each provided in any of a solid, semi-solid or liquid form and possibly by addition of a reconstitution liquid to dilute or dissolve the drug(s). A reconstitution liquid that is added to one or more drugs to prepare a reconstituted drug can be any suitable liquid pharmaceutical diluent including but not limited to water, buffers, organic solvents such as ethanol and dimethylsulfoxide, and combination thereof. A reconstituted drug can also contain other substances that aid in delivery or increase the stability of the reconstituted drug. For example, a hyaluronidase enzyme that increases the rate of subcutaneous infusion could be part of a reconstituted drug.

For purposes of this disclosure, a lyophilized drug is a drug that has been converted into a powdered form or other suitable form by removing some or all of the moisture contained therein. The drug may be lyophilized by any suitable manner including, but not limited to, a freeze dry process. In order to use the lyophilized drug, it must be reconstituted with a reconstitution liquid such as, for example, water or a buffer. The reconstitution process converts the lyophilized drug into a liquid form so it can be injected or infused into an animal such as a human or a veterinary animal such as a cow, a horse, a sheep, a pig, a dog or a cat.

For purposes of this disclosure, stating that Component A is “gravitationally higher” than Component B means that a fluid would flow from Component A to Component B when the fluid is only under the influence of gravity. Likewise, stating that Component X is “gravitationally lower” than Component Y means that a fluid would flow from Component Y to Component X when the fluid is only under the influence of gravity. If the component is a fluid such as, for example, the reconstituted drug, the fluid is considered gravitationally higher than the other component if any portion of the fluid is gravitationally higher than the other component. Likewise, the fluid is considered gravitationally lower than the other component if the entire fluid is gravitationally lower than the other component.

For purposes of this disclosure, stating that the vial is fluidly coupled to the cartridge means that the content of the vial is fluidly coupled to the content of the cartridge. The content may include liquids, gases, powders, or combinations thereof. For example, the vial may initially contain the lyophilized (i.e., powdered) drug and a gas such as air. As another example, the cartridge may initially contain the reconstitution liquid which may be water. For purposes of this disclosure, fluid is defined as any material which is capable of flowing such as, for example, air, liquids, powders, and combinations thereof.

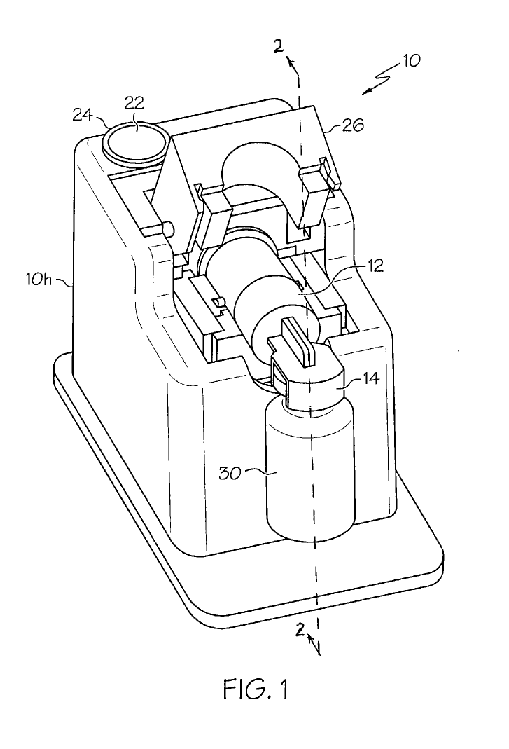

Referring to FIG. 1, a device 10 is shown which is capable of automatically reconstituting a drug, such as e.g., lyophilized drug, or multiple drugs that require diluting and/or mixing. The device 10 may comprise, inter alia, a housing 10h, a cartridge 12, a connector 14, a user input 22, an annunciator 24, and a cover 26. The housing 10h may provide a mechanical structure to which the other components of the device 10 may be mechanically coupled, either directly or indirectly. The housing 10h may also provide protection for the components of the device 10 and may be designed to be aesthetically pleasing to a user. The cartridge 12 may contain a reconstitution liquid such as, for example, water which is capable of reconstituting the drug.

In order to automatically reconstitute the drug, the user may insert a vial 30 containing the drug, such as a lyophilized drug, into the connector 14 and activate the user input 22 (e.g., a pushbutton) in order to start the automatic reconstitution process in one embodiment. Alternatively, in another embodiment the device 10 can automatically detect the vial 30, such as by a contact, optical or Hall Effect sensor. Furthermore, the time and sequence of reconstitution steps can either be set in the device 10 by default or can be set prior to use by virtue of another information source such as an identification label on a vial 30 containing a drug or a vial containing a reconstitution liquid (for example, a bar-code, an OCR code, an RFID-Tag, a mechanical code or a contact code). In addition, the device 10 can, based on the information contained in such codes or user input, guide a user through a complicated reconstitution procedure (such as where multiple drug/reconstitution liquid vials 30 are loaded into the device 10 in a particular order). To further ensure that a complicated series of vial connections and reconstitution steps is carried out properly, the device 10 can further check that the correct vial 30 is in place at a given point in a reconstitution procedure (such as by reading a barcode or any other information source/identifier on the vial) and time periods for reconstitution steps are followed. An alarm or alarms (audible, tactile and/or visual) can be employed to alert a user to change vials at the correct time, and/or to warn the user of incorrect vial insertions and/or attempts by a user to remove a vial prior to a reconstitution step being completed.

After receiving an indication that the (proper) vial 30 is inserted into the connector 14, the device 10 then automatically mixes the reconstitution liquid in the cartridge 12 and the drug in the vial 30 to create a reconstituted drug. After automatically reconstituting the drug, the device 10 may activate the annunciator 24 (e.g., a light) in order to indicate to the user that the reconstitution process has been completed and the reconstituted drug is disposed in the cartridge 12. The cover 26 may provide physical access to the cartridge 12 in order to replace or remove the cartridge 12.

In alternative embodiments, the device 10 can be provided with a cartridge 12 that is either empty initially or one that already contains a drug, and in which the drug can be any of a solid drug, semi-solid drug or a liquid drug. If the drug in the cartridge 12 is a solid or semi-solid drug, the first vial 30 connected to the device 10 contains either a reconstitution liquid or a liquid drug. Likewise, if the first vial 30 contains a solid or semi-solid drug, the cartridge 12 initially contains a reconstitution liquid or a liquid drug. Additional cartridges 12 and/or vials 30 may then be connected to device 10 as needed to form the reconstituted drug, or to dilute or mix multiple drugs.

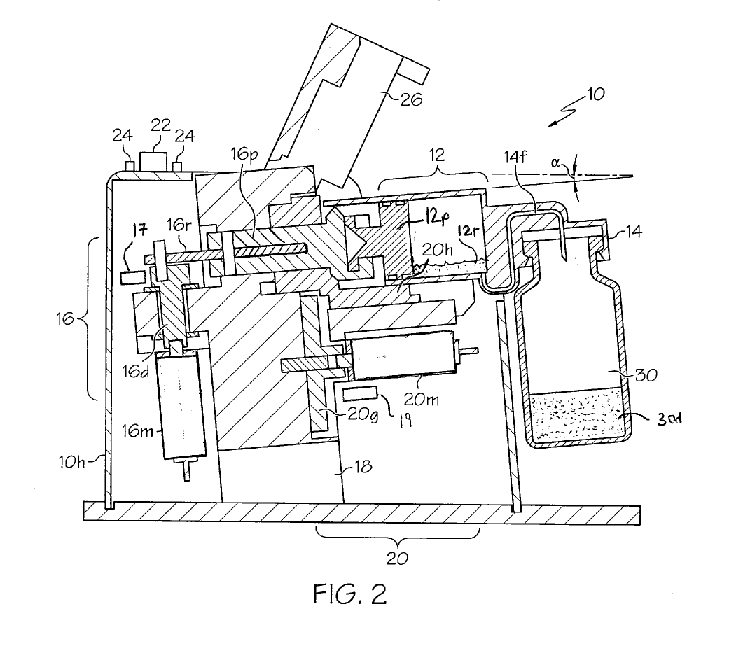

Referring to FIG. 2, a partial section view, taken along section line 2-2 of the device of FIG. 1 is depicted. The device 10 may comprise a cartridge 12, a connector 14, a cartridge drive 16, a controller 18, a vial drive 20, a user input 22, an annunciator 24, and a cover 26. The device 10 may comprise other components not shown such as, for example, a power supply, sensors, electrical cables, and so forth. A detailed description of the components as well as the operation of the device 10 is provided below.

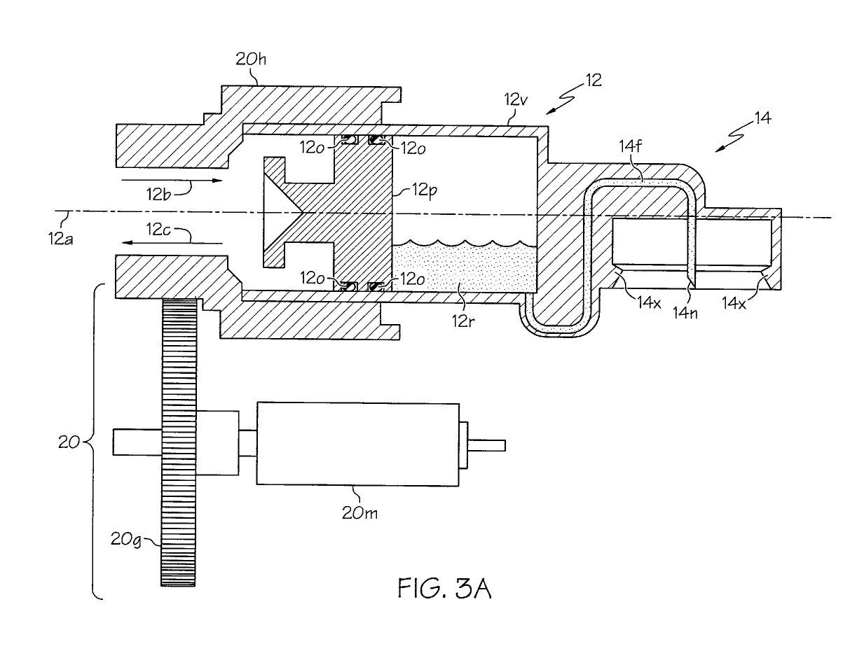

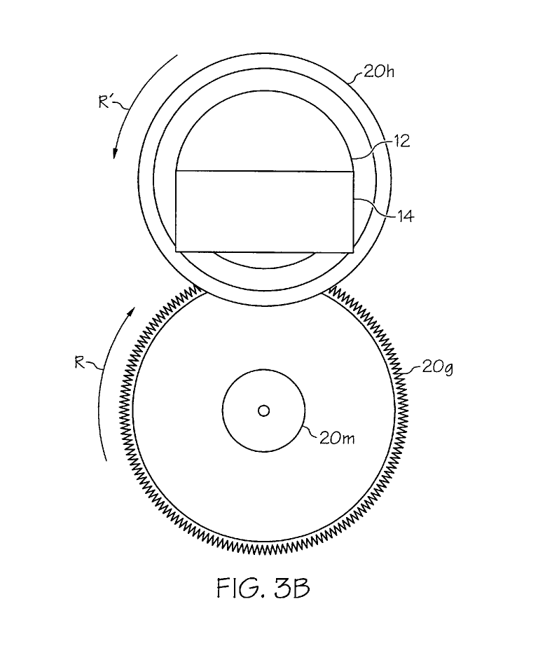

Referring to FIGS. 2 and 3A, the cartridge 12 may contain the reconstitution liquid 12r capable of reconstituting the drug stored in the vial 30, such as a lyophilized drug. The reconstitution liquid 12r is contained within the cartridge 12 and may comprise water or other suitable liquid and may be aseptic. In one embodiment, the cartridge 12 may be removable from the device 10. The cartridge 12 may comprise any suitable size and geometric shape such as, for example, cylindrical, spherical, oval or substantially rectangular cross-sections. In one embodiment, the cartridge 12 may comprise a cylindrical shape. As shown in FIG. 3A, the cartridge 12 may comprise a cylindrical vessel 12v and a plunger 12p. The plunger 12p may be disposed within the cylindrical vessel 12v and is movable along a longitudinal axis 12a of the cylindrical vessel 12v in a first direction 12b and a second direction 12c. The plunger 12p may be fluidly coupled to fluid (e.g., the reconstitution liquid 12r) inside the cylindrical vessel 12v. The plunger 12p may also be mechanically coupled to the cartridge drive 16 (shown in FIG. 2) such that the cartridge drive 16 causes the plunger 12p to move in the first direction 12b and the second direction 12c. The cartridge drive 16 moves the plunger 12p in the first direction 12b to transfer fluid out of the cartridge 12 (e.g., into the vial 30 via the fluid conduit 140. Likewise, the cartridge drive 16 moves the plunger 12p in the second direction 12c to transfer fluid into the cartridge 12 (e.g., from the vial 30 via the fluid conduit 14f).

The plunger 12p may also include one or more seals 12o, which may be o-rings or other similar devices. The seals 12o may comprise rubber, plastic or any other suitable material. For example, in the illustrated embodiment of FIG. 3A, the plunger 12p is provided with two seals 12o. Although two seals 12o are shown, it is contemplated that one seal may be used, or that three or more seals may be used. The seals 12o may be disposed between the plunger 12p and a wall of the cylindrical vessel 12v to inhibit the liquid inside the cylindrical vessel 12v from leaking past the plunger 12p. If two seals 12o are used, they may be disposed on the plunger 12p such that a distance between the two seals 12o is greater than a stroke of the plunger 12p in the first direction 12b and the second direction 12c. For purposes of this disclosure, a “stroke of the plunger in the first direction and the second direction” is defined as the maximum linear movement of the plunger 12p in the first direction 12b, in the second direction 12c, or in a combination thereof.

The movement or stroke of the plunger 12p in the in the first direction 12b and the second direction 12c may operate in one of two manners. First, the cartridge 12 may be designed such that the stroke of the plunger 12p in the first direction 12b and in the second direction 12c is sufficient to transfer all of the fluid in one stroke. For example, a single movement of the plunger 12p in the first direction 12b is sufficient to transfer all of the liquid (e.g., the reconstitution liquid initially stored in the cartridge 12) out of the cartridge 12 and into the vial. In another embodiment, the cartridge 12 may be designed such that the stroke of the plunger 12p in the first direction 12b and in the second direction 12c is less than a volume of fluid in the cartridge 12, and a plurality of strokes of the plunger 12p is required to transfer all of the fluid out of the cartridge 12 and to transfer all of the fluid back into the cartridge 12. Other designs of the plunger 12p and the cartridge 12 may be used as well.

As shown best in FIG. 2, the cartridge drive 16 may comprise a motor 16m, a first gear 16d, a second gear and shaft 16r, and a link 16p. The motor 16m may be a rotary motor such as, for example, a direct current (DC) electric motor which is electrically coupled to the controller 18. The motor 16m may be mechanically coupled to the first gear 16d such that the motor 16m is capable of rotating the first gear 16d about a longitudinal axis of the first gear 16d. The second gear and shaft 16r may be mechanically coupled to the first gear 16d such that rotation of the first gear 16d causes rotation of the second gear and shaft 16r about a longitudinal axis 12a (FIG. 3A) of the cartridge 12. The second gear and shaft 16r may be mechanically coupled to the link 16p such that rotational motion of the second gear and shaft 16r causes a corresponding linear motion of the link 16p in a direction substantially parallel to the longitudinal axis 12a of the cartridge 12. For example, in one embodiment, an end portion of the shaft may be threaded which meshes with a nut provided in the link 16p, and in which the second gear and shaft 16r are fixed within the housing 10h, except for rotation, such that rotation of the second gear and shaft 16r causes linear motion of the link 16p as the nut moves relative about the threaded portion of the shaft. In another embodiment, the shaft may be fixed to the link 16p, such that the second gear when rotated causes relative (linear) movement of the shaft and link 16p. The link 16p may be mechanically coupled to the cartridge 12 (e.g., the plunger 12p of the cartridge 12) such that linear movement of the link 16p causes a change in pressure of fluid in the cartridge 12 in order to transfer fluid into or out of the cartridge 12.

In the embodiment shown in FIG. 2, activation of the motor 16m causes the motor to rotate such that the rotary motion is converted into linear motion at the link 16p. The link 16p of the cartridge drive 16 may be mechanically coupled to the plunger 12p of the cartridge 12, wherein movement of the motor 16m causes the plunger 12p to move, as shown by FIG. 3, either in the first direction 12b or the second direction 12c. In this manner, the cartridge drive 16 changes the pressure of the fluid in the cartridge 12 to transfer fluid into or out of the cartridge 12 through the fluid conduit 14f. For example, in one embodiment rotation of the motor 16m in one direction causes the plunger 12p to move in the first direction 12b, which increases pressure on fluid in the cartridge 12 and causes the fluid in the cartridge 12 to be transferred to the vial 30 when the vial 30 is inserted into the connector 14.

Likewise, in this embodiment rotation of the motor 16m in the other direction causes the plunger 12p to move in the second direction 12c, which decreases pressure on fluid in the cartridge 12 and causes the fluid in the vial 30 to be transferred into the cartridge 12 when the vial 30 is inserted into the connector 14, and preferably when the vial 30 is gravitationally above the cartridge 12 such that air is not introduced into the liquid. In other embodiments, the motor 16m may rotate only in one direction wherein bidirectional rotation is facilitated and selected by a cam and/or gearbox which moves the plunger 12p backwards and forwards. As bidirectional gearing arrangements are known by those skilled in the art no further discussion is provided.

The cartridge drive 16 (e.g., through the motor 16m) may be electrically coupled to the controller 18 (FIG. 2) such that the controller controls whether fluid is transferred into or out of the cartridge 12 by activating the cartridge drive 16 in a suitable manner. For example, the controller 18 may send an electrical signal (e.g., an electrical voltage or current) to the motor 16m to activate the cartridge drive 16. The cartridge drive 16 may comprise other components which may facilitate its operation. For example, the cartridge drive 16 may further comprise a position sensor or encoder 17 (FIG. 2) which senses the rotational position of the cartridge drive 16 (or the linear position of the link 16p) and provides feedback to the controller 18. Other sensors and components may be used as well, as is known in the art.

In the embodiment shown in FIGS. 2, 3A, and 3B, the cartridge 12 and the connector 14 are mechanically coupled to each other such that they move in unison. As discussed herein, activation of the vial drive 20 may adjust the position of the connector 14 (and the vial 30 inserted therein). This adjustment may take place around a longitudinal axis 12a of the cartridge 12. Accordingly the link 16p of the cartridge drive 16 and the plunger 12p of the cartridge 12 may be mechanically coupled so that they are capable of rotating with respect to each other about the longitudinal axis 12a of the cartridge 12, while still moving in unison in the direction of the longitudinal axis 12a (e.g., directions 12b and 12c). The link 16p may also have a “J” shape, as shown in FIG. 2, so that the cartridge 12 may be removably inserted into the device 10 while permitting the link 16p and the plunger 12p may be mechanically coupled to each other.

Although the cartridge 12 and the connector 14 are mechanically coupled to each other in the embodiments shown and described herein, it is contemplated that, in other embodiments, they are not mechanically coupled to each other. In these embodiments, the vial drive 20, when activated, may only adjust the position of the connector 14. That is, activating the vial drive 20 may have no effect on the cartridge 12, which may be mechanically coupled to the device 10, for example. It is contemplated that other mechanical arrangements may be used as well, as is known in the art. Furthermore, the relative positions of the cartridge 12 and the vial 30 may include a number of arrangements. For example, in one embodiment a longitudinal axis of the cartridge 12 is substantially perpendicular to a direction of gravity. In this embodiment, a longitudinal axis of the vial 30 may be substantially perpendicular to the longitudinal axis of the cartridge 12; the vial drive 20 may be operable to adjust the orientation of the vial 30 by axially rotating the vial about the longitudinal axis of the cartridge 12; and the vial drive 20 may be mechanically coupled to the cartridge 12, and the vial drive rotates a body of the cartridge about its longitudinal axis, which adjusts the orientation of the vial 30.

In another embodiment, the vial drive 20 may be operable to adjust the orientation of the vial 30 by axially rotating the vial about an axis substantially perpendicular to a direction of gravity. In still another embodiment, a longitudinal axis of the cartridge 12 is substantially parallel to a direction of gravity. In this embodiment, a longitudinal axis of the vial 30 may be substantially parallel to the longitudinal axis of the cartridge 12, or the orientation of the vial 30 may be adjusted by rotating the vial 30 and the cartridge 12 about an axis substantially perpendicular to the direction of gravity.

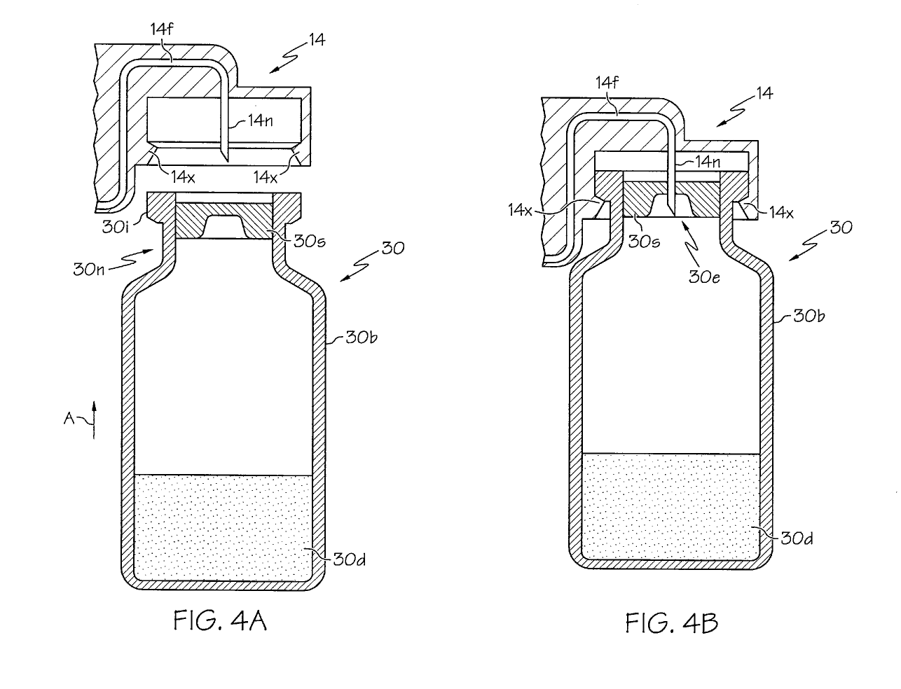

Referring to FIGS. 2, 3A, 3B, 4A, and 4B, the connector 14 provides a fluid conduit 14f which fluidly couples the vial 30 to the cartridge 12. The vial 30 may be removably inserted into the connector 14 by moving the vial 30 in direction A as shown in FIG. 4A. After the vial 30 has been inserted and the drug automatically reconstituted by the device 10, the vial 30 may be removed by the user. In order to insert the vial 30 into the connector 14, the user may push the vial 30 into the connector 14 in the direction “A” as shown in FIG. 4A. An entry point 30e is defined where the fluid conduit 14f enters the vial 30 when the vial 30 is inserted into the connector 14. The connector 14 may have a ridge 14x or other suitable structures to hold the vial 30 in place after it has been inserted by the user into the connector 14. The ridge 14x may be disposed on the connector 14 so that it engages the rim 30i of the vial 30 and holds the vial 30 in the connector 14 through friction in one embodiment or a set of one or more snap fits around the rim of the connector 14 in another embodiment. It is contemplated that the connector 14 may use other techniques to retain the vial 30 after being inserted into the connector 14.

The fluid conduit 14f of the connector 14 may include a needle 14n disposed at the connector such that, when the vial 30 is inserted into the connector 14, the needle 14n is inserted into the vial 30 at the entry point 30e. The needle 14n may comprise steel or other suitable material. In still other embodiments, the needle may be plastic and an integral part of the connector 14. The vial 30 may have a stopper 30s disposed in the neck of the vial 30 which seals the vial 30 and the drug 30d contained therein. The stopper 30s may comprise rubber, plastic, or other suitable material. The needle 14n may be hollow to allow fluid to pass through it and may also have a sharp tip which is capable of puncturing and passing through the stopper 30s when the vial 30 is inserted into the connector 14. The needle 14n may be of sufficient length to pass through and emerge from the stopper 30s so that the tip of the needle 14n enters the vial 30 and is fluidly coupled to the vial 30. The connector 14 may also permit the user to remove the vial 30 (e.g., after reconstitution of the drug) by overcoming the friction or mechanical coupling created by the ridge 14x and pulling the vial 30 out of the connector 14. The vial 30 may also include a septum (not shown) which seals the vial 30 before it is used. When the vial 30 is inserted in the connector 14, the needle 14n may pass through the septum of the vial 30 such that location where the needle 14n passes through the septum defines the entry point of the vial 30.

In another embodiment, the fluid conduit comprises a needle disposed at the connector 14 such that when the vial 30 is inserted into the connector, the needle is inserted through a septum (not shown) of the cartridge 12 to make a fluid connection with the cartridge 12. In still another embodiment, the cartridge 12 may be rotated about a longitudinal axis of the cartridge in order to break a seal, which creates a fluid connection between the connector 14 and the cartridge 12. Other similar manners of fluidly coupling the cartridge 12 to the vial 30 may be used, as is known in the art.

The vial 30 may have a body 30b, a neck 30n, and a rim 30i and may comprise glass, plastic, metal, or other suitable material. In still other embodiments, the vial 30 may be rigid, or have flexible membranes such as, e.g., in the form of a bag. The neck 30n and the rim 30i may be arranged so that the vial 30 can be removably inserted into the connector 14. The vial may also have a stopper 30s which is inserted into the neck 30n to seal the drug 30d inside the vial 30. The vial 30 may have a generally cylindrical shape although other geometric shapes are contemplated. The neck 30n may be narrower than both the body 30b and the rim 30i such that the rim 30i provides a surface which allows the vial 30 to be frictionally coupled to the connector 14, as discussed herein. The vial 30 may be based on a standard vial format which is used in other types of medical application. Using a standard vial format may allow the vial 30 to be cost-effective since the manufacturer may take advantage of economies of scale and existing manufacturing processes. Alternatively, the vial 30 may be specially designed and configured for the devices and methods described herein.

FIGS. 3A and 3B depict the vial drive 20, which may comprise a housing 20h, a motor 20m, and a gear 20g. The vial drive 20 may permit the device 10 to control the orientation of the vial 30. In the embodiment shown, the connector 14 is mechanically coupled to the cartridge 12 such that rotation of the cartridge 12 around a longitudinal axis 12a of the cartridge 12 causes the connector 14 to orient the position of the vial. The cartridge 12 may be mechanically coupled to the housing 20h such that the cartridge 12 and the housing 20h rotate in unison. In one embodiment, the cartridge 12 may be removably inserted into the housing 20h by the user. The housing 20h may have teeth (not shown) disposed around its perimeter which engages the gear 20g such that rotation of the gear 20g causes the housing 20h (and, therefore, the cartridge 12 and the vial) to rotate around the longitudinal axis 12a of the cartridge 12. The motor 20m may be mechanically coupled to the gear 20g such that the motor 20m controls the rotation of the gear 20g. In this manner, the motor 20m (e.g., as activated by the controller 18) ultimately controls the orientation of the connector 14 and the vial 30 inserted therein.

The vial drive 20 (e.g., through the motor 20m) may be electrically coupled to the controller 18 (FIG. 2) such that the controller controls the orientation of the vial 30 by activating the vial drive 20. The controller 18 may send an electrical signal to the motor 20m to control the orientation of the vial 30. The vial drive 20 may comprise other components which may facilitate its operation. For example, the vial drive 20 may further comprise a position sensor or encoder 19 (FIG. 2) which senses the rotational position or orientation of the vial drive 20 and provides feedback to the controller such that the orientation of the vial 30 may be detected and/or determined. Other sensors and components may be used as well to detect orientation of the vial 30.

FIG. 3B shows an end view of the vial drive 20. When the motor 20m rotates the gear 20g in the R direction, the cartridge 12 and connector 14 (shown without the vial 30 connected thereto) rotate in the R′ direction. The vial drive 20 may rotate in either direction (e.g., the R direction or in the opposite direction). For example, the vial drive 20 may rotate in the R direction to orient the connector (and the vial) in one orientation; and the vial drive 20 may rotate in the opposite direction to orient the connector (and the vial) in another orientation. In short, it is to be understood that the vial drive 20 may rotate the connector 14 in any suitable direction in order to orient the vial 30 (FIG. 2). It is also contemplated that other mechanical systems may be used to orient the connector 14 and vial 30. For example, instead of a gear arrangement, the vial drive 20 may have a cam/cam follower arrangement in order to orient the connector 14 and vial 30. In addition, the vial drive 20 may rotate and axially orientated the vial 30 and cartridge 12 about an axis perpendicular to the longitudinal axis of the vial and cartridge. In still other embodiments, the vial drive 20 may be mechanically coupled to the vial 30, the cartridge 12 or the connector 24, or any combination of all three components.

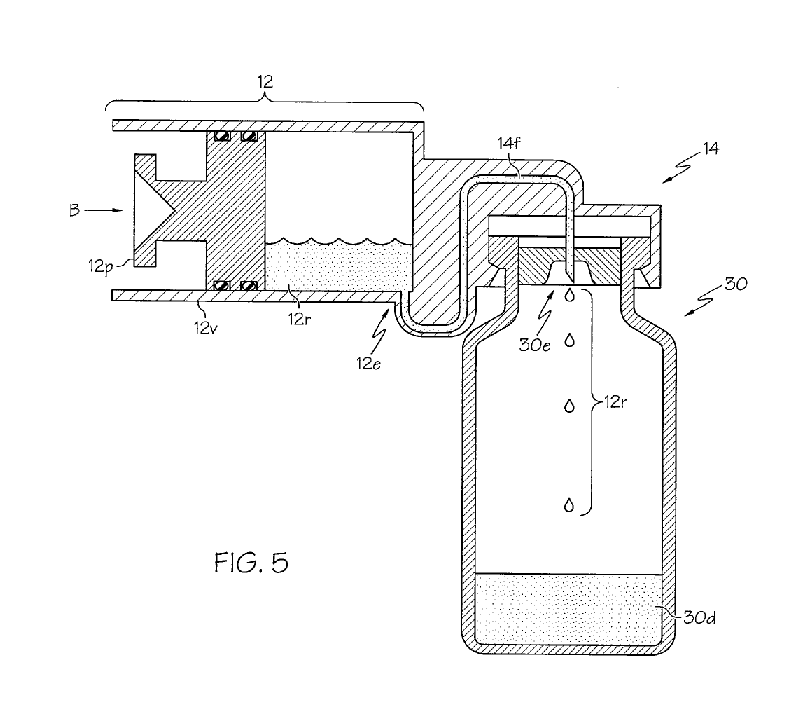

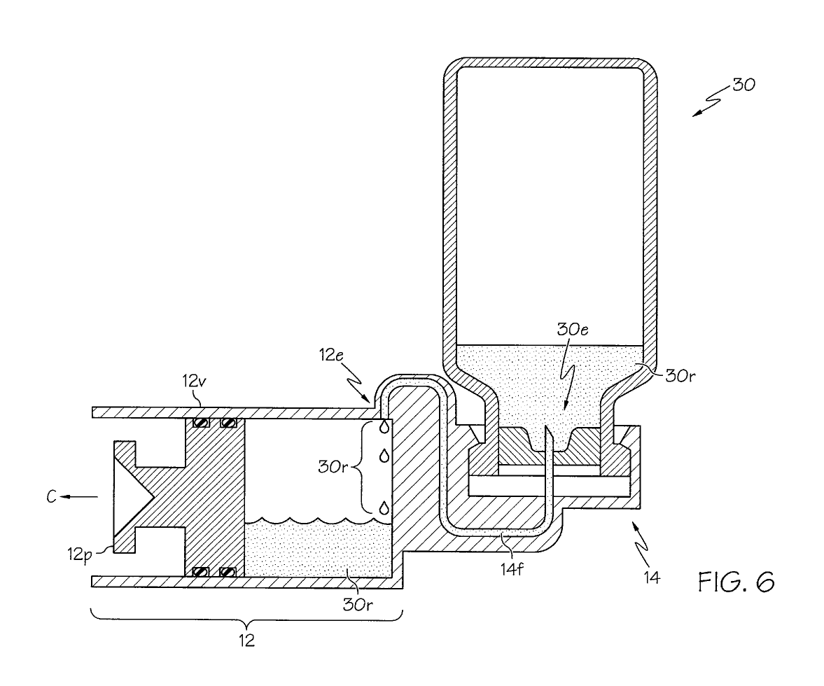

FIGS. 5 and 6 depict a side view of the cartridge 12 and connector 14 for the device 10 from FIG. 1. In FIG. 5, the device is shown automatically transferring the reconstitution liquid 12r out of the cartridge 12, through the fluid conduit 14f, and into the vial 30. The device 10 may automatically adjust the orientation of the vial 30 by activating the vial drive 20 (FIG. 3A) such that the entry point 30e of the vial 30 is gravitationally higher than the drug 30d in the vial 30. The transfer of the fluid is performed by activating the cartridge drive 16 (FIG. 2) to move the plunger 12p in the direction B, which causes the pressure on the reconstitution liquid 12r in the cartridge (and any other fluid contained therein) to increase. The reconstitution liquid 12r enters the vial at the entry point 30e. The result is that the reconstitution liquid 12r is transferred out of the cartridge 12 and into the vial 30, thus mixing with the drug 30d. Some or all of the reconstitution liquid 12r may be transferred into the vial 30.

After some or all of the reconstitution liquid 12r has been transferred into the vial 30, the drug 30d becomes a reconstituted drug 30r through the natural mixing of the reconstitution liquid 12r and the drug 30d. The device 10 may wait a reconstitution time period to allow the mixing to complete and/or any chemical reactions to conclude. For example, the reconstitution time period can be implemented in the device 10 by the controller 18 waiting automatically for a desired period that has set either programmatically or discretely (binary registers, dip switches, timing circuits, etc). The reconstitution time period may range from about 1 second to 10 minutes or more. In one embodiment, the reconstitution time period is about 60 seconds.

In FIG. 6, the device is shown automatically transferring the reconstituted drug 30r out of the vial 30, through the fluid conduit 14f, and into the vial 30. The device 10 may automatically adjust the orientation of the vial 30 by activating the vial drive 20 (FIG. 3A) such that the entry point 30e of the vial 30 is gravitationally lower than the reconstituted drug 30r in the vial 30. The transfer of the fluid is performed by activating the cartridge drive 16 (FIG. 2) to move the plunger 12p in the direction C, which causes the pressure on fluid in the cartridge to decrease. The reconstituted drug 30r leaves the vial at the entry point 30e. The result is that the reconstituted drug 30r is transferred out of the vial 30 and into the cartridge 12. Some or all of the reconstituted drug 30r may be transferred into the cartridge 12.

Referring to FIGS. 2 and 6, the fluid conduit 14f may enter the cartridge 12 at an entry point 12e. The entry point 12e of the cartridge 12 may be disposed such that, when fluid is being transferred from the vial 30 to the cartridge 12 (as shown in FIG. 6), the entry point 12e is gravitationally higher than fluid in the cartridge 12. This may allow the fluid to enter the cartridge 12 in a manner which inhibits the formation of bubbles in the cartridge 12. That is, the entry point 12e may be disposed such that the fluid entering the cartridge (e.g., the reconstituted drug 30r in FIG. 6) does not enter below the liquid already in the cartridge 12. In order to insure that the entry point 12e is gravitationally higher than fluid in the cartridge 12, the longitudinal axis 12a of the cartridge 12 may be tilted at a tilt angle α, as shown in FIG. 2, so that the entry point 12e of the cartridge 12 is always gravitationally higher and fluid in the cartridge 12 when fluid is being transferred from the vial 30 to the cartridge 12. In one embodiment, the tilt angle α may be about 5°. Other suitable tilt angles may be used as well. This may allow the device 10 to be disposed on a surface which is not exactly level and still inhibit the formation of bubbles in the cartridge 12 when fluid is transferred from the vial 30 to the cartridge 12.

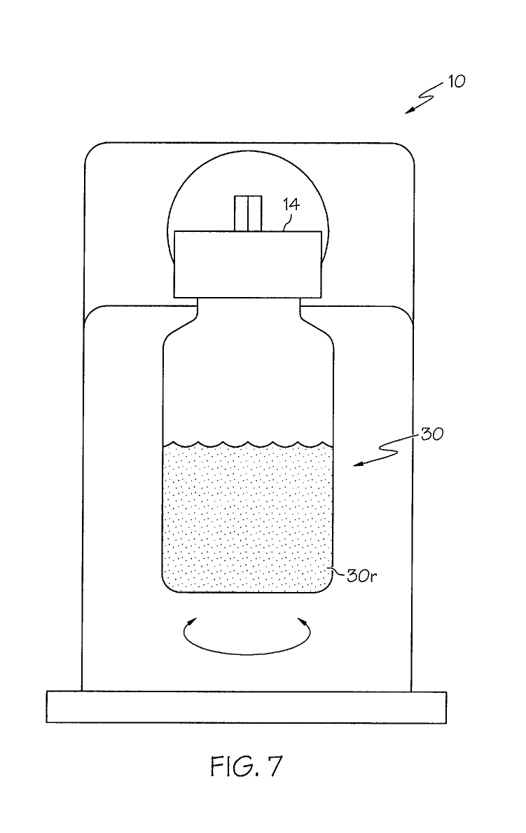

FIG. 7 depicts a front view of the device of FIG. 1 with the vial 30 attached removably to the connector 14 as well as depicting the reconstituted drug 30r being agitated by the device 10 via the double-ended arrow. After the reconstitution liquid 12r has been transferred from the cartridge 12 into the vial 30, the natural mixing creates the reconstituted drug 30r. However, in order to speed up the mixing process, the device 10 may agitate the reconstituted drug 30r by activating the vial drive 20 in a manner to cause the vial 30 to move back and forth. This movement may be slow or quick and may be performed for a suitable amount of time. For example, after the reconstitution liquid has been transferred into the vial 30, the controller 18 (FIG. 2) may activate automatically the vial drive 20 to agitate the vial 30 for a period of time to in order to facilitate the mixing process. In one embodiment, agitation results from a shaking motion which moves the vial 30 back and forth at a rate of about 4 times per second for a period of 10 seconds. Other motions such as tilting, side-to side movement, spinning, and combinations thereof, as well as other rates may be used in other embodiments.

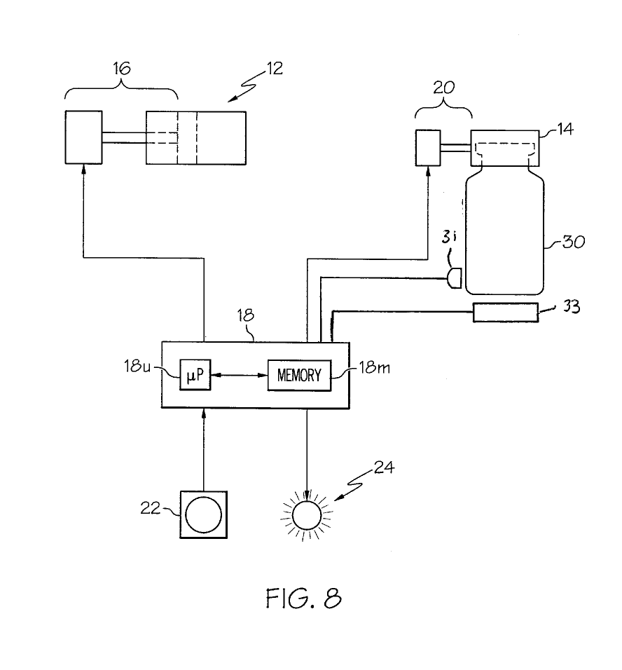

FIG. 8 depicts in block diagram a schematic of a device for automatically reconstituting a drug according to one or more embodiments shown and described herein. The device may comprise a cartridge drive 16, a controller 18, a vial drive 20, a user input 22, and an annunciator 24. The cartridge drive 16 may be mechanically coupled to the cartridge 12 and may be able to change pressure of fluid in the cartridge 12 to transfer fluid into or out of the cartridge 12 through the fluid conduit, as described herein. The cartridge drive 16 may comprise an electric motor, a first gear, a second gear and shaft, and a plunger (as shown in FIG. 2). It is contemplated that other types of actuators may be used as well such as, for example, piezoelectric actuators and electro-active polymers. The controller 18 may be electrically coupled to the cartridge drive 16 such that the controller 18 automatically controls transfer of fluid into or out of the cartridge 12 by activating the cartridge drive 16.

In one embodiment, the cartridge drive 16 comprises an electric motor, and the controller 18 automatically controls transfer of fluid into or out of the cartridge 12 by activating the electric motor. In this embodiment, the electric motor may comprise a DC electric motor which rotates in one direction when a positive electrical current is applied to it, and which rotates in the opposite direction when a negative electrical current is applied to it. In this manner, the controller 18 may control automatically the direction of rotation of the motor which correspondingly controls whether the cartridge drive 16 transfers fluid into or out of the cartridge 12. The controller 18 may further comprise a power circuit (not shown) for the motor in order to step up the voltage and/or current to a suitable level for driving the motor.

In other embodiments, e.g., when the motor 16m always drives in one direction with a cam to move the plunger 12p backwards and forwards, repeated strokes pump all the reconstitution liquid 12r from the cartridge 12 and into the vial 30 when the vial is gravitationally below the cartridge, or draws the drug 30d from the vial when the vial 30 is gravitationally higher than the cartridge 12.

The cartridge drive 16 may further comprise one or more sensors (not shown) in order to provide feedback to the controller 18 regarding the state of the cartridge drive 16. For example, a position sensor may be disposed on the plunger of the cartridge drive 16 in order to allow the controller 18 to ascertain the position of the plunger. This may allow the controller 18 to accurately control the amount of fluid transferred as well as the rate of the transfer. As an alternative, the cartridge drive 16 may have one or more proximity sensors to detect when the plunger is fully extended or fully retracted. In this embodiment, the controller 18 may activate the cartridge drive 16 to transfer fluid into or out of the cartridge 12 until the one or more sensors indicate that the plunger is fully extended (e.g., for transferring fluid out of the cartridge 12) or fully retracted (e.g., for transferring fluid into the cartridge 12), at which time the controller 18 deactivates the cartridge drive 16. In summary, there are numerous ways for the controller 18 to activate the cartridge drive 16 and control the transfer of fluid into or out of the cartridge 12.

Referring still to FIG. 8, the vial drive 20 may be mechanically coupled to the connector 14 and may be able to adjust the orientation of the vial 30 when the vial 30 is inserted into the connector 14, as described herein. The vial drive 20 may comprise an electric motor, a gear, and a housing (as shown in FIGS. 2, 3A, and 3B). It is contemplated that other types of actuators may be used as well such as, for example, piezoelectric actuators and electro-active polymers. The controller 18 may be electrically coupled to the vial drive 20 such that the controller 18 controls the orientation of the vial 30 by activating the vial drive 20.

In one embodiment, the vial drive 20 comprises an electric motor, and the controller 18 controls the orientation of the vial 30 by activating the electric motor. In this embodiment, the electric motor may comprise a DC electric motor which rotates in one direction when a positive electrical current is applied to it, and which rotates in the opposite direction when a negative electrical current is applied to it. In this manner, the controller 18 may control the direction of rotation of the motor which correspondingly controls the orientation of the vial 30. The controller 18 may further comprise a power circuit (not shown) for the motor in order to step up the voltage and/or current to a suitable level for driving the motor.

The vial drive 20 may further comprise one or more sensors (not shown) in order to provide feedback to the controller 18 regarding the state of the vial drive 20. For example, a position sensor may be disposed on the motor of the vial drive 20 in order to allow the controller 18 to ascertain and control the orientation of the vial 30. As an alternative, the vial drive 20 may have one or more proximity sensors to detect when the entry point in the vial is gravitationally higher or lower than fluid in the vial. In this embodiment, the controller 18 may activate the vial drive 20 to orient the vial 30 until the one or more sensors indicate that the vial 30 is oriented in the desired manner (e.g., in an orientation for transferring fluid out of the cartridge 12 or in an orientation for transferring fluid into the cartridge 12). In summary, there are numerous ways for the controller 18 to activate the vial drive 20 and control the orientation of the vial 30. A sensor 31 may also be provided such that the controller 18 can automatically detect when the drug has been fully dissolved by the reconstitution liquid. Examples of such suitable sensors include optical sensors which detect either a color change, or a transmissive (interrupter) sensors, or reflective sensors which detects either the presence or absence of particulates in the reconstituted drug, and the likes. In addition, a heater 33 may be provided such that the controller 18 can automatically heat (gently) the vial 30 in order, for example, to heat the contents of the vial to a predetermined desired temperature, and/or to accelerate the reconstitution process such as, for example, if after a pre-determined time particulates are still detected by the sensor 31 in the vial 30. In an alternative embodiment, the heater 33 may be replaced with an ultrasonic device/transducer or supplemented therewith, such that ultrasonic waves may be applied to help speed up the reconstitution process and/or to reduce fraction of undissolved settling.

Referring still to FIG. 8, the user input 22 may comprise a pushbutton, a switch, or other suitable device. The user input 22 may be electrically coupled to the controller 18 such that the controller 18 is able to determine whether the user is activating the user input 22. In one embodiment, the user may insert the vial 30 into the connector 14 and activate (e.g., press) the user input 22 to inform the controller 18 that the reconstitution process is ready to begin. The annunciator 24 may comprise a light, a light emitting diode (LED), a graphical display or other suitable device. The annunciator 24 may be electrically coupled to the controller 18 such that the controller 18 controls the activation of the annunciator 24. For example, if the annunciator 24 is a light, the controller 18 controls whether the annunciator 24 is activated (e.g., illuminated) or deactivated (e.g., extinguished). The annunciator 24 may comprise other types of devices such as, for example, acoustic devices, vibratory devices, or combinations thereof. In the embodiment shown in FIG. 1, the user input 22 is a pushbutton, and the annunciator 24 is an LED which surrounds the pushbutton as an annular ring. The annunciator 24 may indicate to the user the status of the reconstitution device. For example, the annunciator 24 may flash when the drug has been reconstituted and the vial 30 is ready to be removed from the device. The annunciator 24 may also indicate other status information such as, for example, whether an error occurred during the reconstitution process, whether the battery is low, etc.

Referring still to FIG. 8, the controller 18 may comprise a microcontroller 18u and a memory 18m. The microcontroller 18u may be a 4-bit, 8-bit, 16-bit, or any other suitable device. For example, the microcontroller 18u may be an 8-bit device available from Microchip Technologies located in Chandler, Ariz. It is contemplated that other microcontrollers, both from Microchip Technologies and other manufacturers, may be used as well. The microcontroller 18u may be electrically coupled to the memory 18m such that the microcontroller 18u is capable of executing computer-readable and computer-executable instructions stored in the memory 18m. In one embodiment, the microcontroller 18u and the memory 18m reside on the same monolithic device. The computer-readable and computer-executable instructions stored in the memory 18m may embody one or more of the methods described herein to automatically reconstitute a drug.

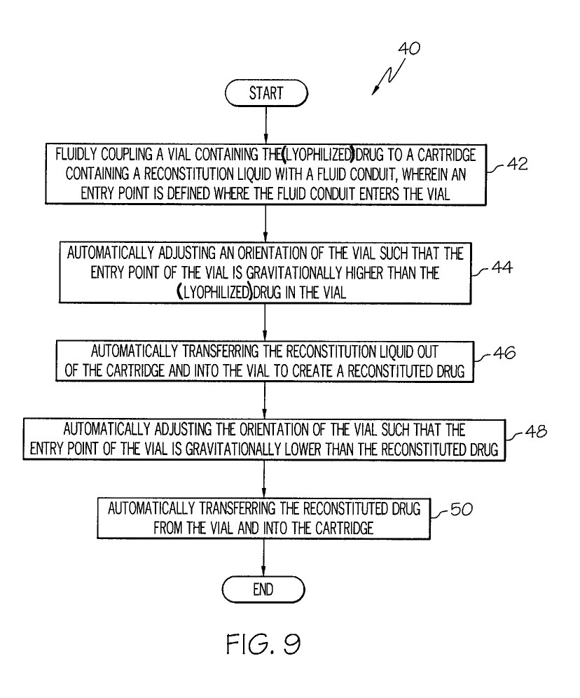

FIG. 9 depicts a method 40 for automatically reconstituting a drug. The steps of the method 40 may be embodied in software instructions contained in the memory 18m (FIG. 8) which permit the microcontroller 18u to automatically reconstitute a drug using the drives 16, 20 of the device 10. At step 42, the user may fluidly couple the vial 30 containing the drug to the cartridge 12 containing the reconstitution liquid via a fluid conduit. For example, the user may insert the vial 30 into the connector 14 having a needle which punctures the vial (e.g., the vial stopper) and fluidly coupled the vial to the cartridge 12. The user may then activate the user input which informs the microcontroller 18u of the device 10 that the reconstitution process may begin. The microcontroller 18u of the device 10 may then automatically reconstitute the drug 30d by performing the following steps, which may be performed in any suitable order.

At step 44, the microcontroller 18u of the device 10 may automatically adjust an orientation of the vial 30 such that the entry point of the vial is gravitationally higher than the drug 30d in the vial. At step 46, the microcontroller 18u of the device 10 may automatically transfer the reconstitution liquid 12r out of the cartridge 12 and into the vial 30 to create a reconstituted drug 30r. At step 48, the microcontroller 18u of the device 10 may automatically adjust the orientation of the vial 30 such that the entry point of the vial is gravitationally lower than the reconstituted drug 30r. And at step 50, the microcontroller 18u of the device 10 may automatically transfer the reconstituted drug 30r from the vial 30 and into the cartridge 12. At the end of the reconstitution process, the microcontroller 18u of the device 10 may automatically activate the annunciator 24 to indicate that the reconstituted drug 30r is disposed in the cartridge 12.

The method 40 may include other steps as well. For example, the microcontroller 18u of the device 10 may automatically agitate the reconstituted drug 30r in the vial 30 by activating the vial drive 20. Furthermore, the microcontroller 18u of the device 10 may automatically wait a reconstitution time period after the reconstitution liquid 12r is transferred out of the cartridge 12 and into the vial 30 with the drug 30d. This reconstitution time period may allow the mixing of the drug and the reconstitution liquid to complete and may, for example, be from 10 seconds or less to ten minutes or more. Finally, the microcontroller 18u of the device 10 may automatically adjust the orientation of the vial 30 such that the entry point of the vial is gravitationally higher than a body of the vial after the reconstituted drug 30r has been transferred from the vial 30 into the cartridge 12 to allow a user to fluidly uncouple the vial 30 from the connector 14 of the cartridge 12. These and other suitable steps may be included in the method and may be performed in any suitable order.

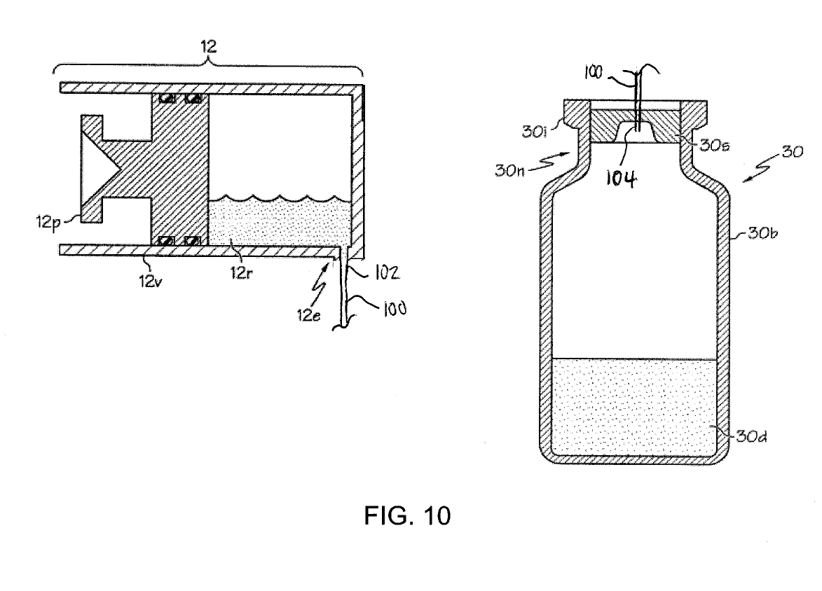

FIG. 10 depicts a simplified fluid conduit 100 between the vial 30 and the cartridge 12. It is to be appreciated that for the purposes of the application a complicated fluid path is not generally necessary. As such, the fluid conduit 100 generally has a first end 102 couple to the cartridge 12 and a second end 104 connected to the vial 30 such that the vial 30 and cartridge 12 are fluidly connected. The fluid conduit 100 may be any suitable shape, length, and material, and may be singled or multi-layered (e.g., a tube inside a tube), as well as a channel, pipe, tube, or duct that is suitable for conveying the content(s) of the vial 30 to the cartridge 12 and vice versa. Accordingly, although the hereto now described embodiments have involved the cartridge 12 and vial 30 being arranged relative to one another at about 90°, other orientations situating the cartridge 12 and vial 30 at a relative angle greater and less than 90° may also be used.

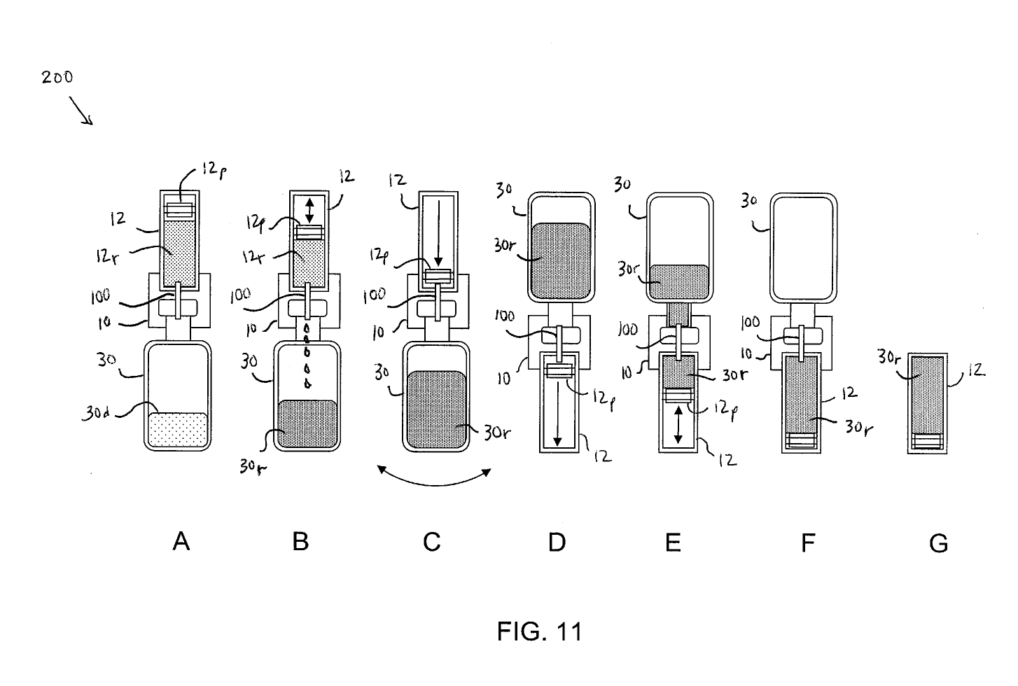

For example, FIGS. 11A-G depict an in-line system 200 provided by the device 10 in which the cartridge 12 and vial 30 as well as a method for automatically reconstituting a drug using the system. In this example and with reference made to also FIG. 8, FIG. 11A depicts the vial 30 containing the drug fluidly couple to the cartridge 12 containing the reconstitution liquid via the fluid conduit 100 and oriented relative to one another at about 180° by the device 10. As in the previous method 40 (FIG. 9), the user may insert the vial 30 into a connector 14 (FIG. 8) of the device 10 which fluidly couples the vial to the cartridge 12 via the fluid conduit 100. The user may then activate the device 10, e.g., via a user input 22 (FIG. 8) which informs the microcontroller 18u (FIG. 8) of the device 10 that the reconstitution process may begin.

For example, when the reconstitution process begins when using the in-line system 200, the microcontroller 18u of the device 10 may automatically adjust the orientation of the vial 30 such that the entry point of the vial is gravitationally higher than the drug 30d in the vial. Next, as depicted by FIG. 11B, the microcontroller 18u of the device 10 automatically transfers the reconstitution liquid 12r out of the cartridge 12 and into the vial 30 to create a reconstituted drug 30r. For example, transferring of reconstitution liquid 12r to the vial 30 may be accomplished by the microcontroller 18u activating in a first manner the cartridge drive 16 (FIG. 8) which causes the plunger 12p to move in a first direction. After completing the transfer as depicted by FIG. 11C, the microcontroller 18u of the device 10 automatically adjusts the orientation of the vial 30 such that the entry point of the vial is gravitationally lower than the reconstituted drug 30r as depicted by FIG. 11D. Next as depicted by FIGS. 11D and E, the microcontroller 18u of the device 10 automatically transfers the reconstituted drug 30r from the vial 30 and into the cartridge 12. For example, transferring of reconstitution liquid 12r to the vial 30 may be accomplished by the microcontroller 18u activating in a second manner the cartridge drive which causes the plunger 12p to move in a second direction that is opposite to the first direction. At the end of the reconstitution process as depicted by FIG. 11F, the microcontroller 18u of the device 10 may automatically activate the annunciator 24 (FIG. 8) to indicate that the reconstituted drug 30r is disposed in the cartridge 12.

The above described method may include other steps as well. For example, the microcontroller 18u of the device 10 may automatically agitate the reconstituted drug 30r in the vial 30 by activating the vial drive 20 such that the vial 30 is moved, e.g., in a side-to-side motion as depicted by the arrow in FIG. 11C. Furthermore, the microcontroller 18u of the device 10 may automatically wait a reconstitution time period after the reconstitution liquid 12r is transferred out of the cartridge 12 and into the vial 30 with the drug 30d. For example, this reconstitution time period may allow the mixing of the drug 30d and the reconstitution liquid 12r to complete and may, for example, be from 10 seconds or less to ten minutes or more. Finally, the microcontroller 18u of the device 10 may automatically adjust the orientation of the vial 30 such that the entry point of the vial is gravitationally higher than a body of the vial after the reconstituted drug 30r has been transferred from the vial 30 into the cartridge 12. Afterwards, a user may fluidly uncouple the vial 30 from the connector 14 of the cartridge 12 as depicted by FIG. 11G. These and other suitable steps may be included in the method and may be performed in any suitable order as well as one or more of the process step repeated any number of times as needed in order to provide the reconstituted drug 30r.

It should now be understood that the devices and methods described herein may automatically reconstitute a drug. This may allow a user to manually insert a vial containing the drug into a connector of the device and start the automatic reconstitution process. The device may then automatically reconstitute the drug and, upon completion of the reconstitution process, may inform the user via an annunciator that the reconstitution process has completed and the reconstituted drug is disposed in the cartridge. Automation increases safety because it can reduce exposure of healthcare workers to potentially toxic substances in any case, and further permits reconstitution to be performed in a safe environment such as under a laminar flow hood. An advantage of certain embodiments is that due to the automated reconstitution process the liquid transfer between cartridge and vial takes place under flow conditions avoiding turbulences during the transfer processes. Drug specific reconstitution times can be predefined so that administering can start at earliest after the time obliged for reconstitution. Still another advantage of certain embodiments is that after completing the reconstitution process, the cartridge is filled entirely with the reconstituted drug (which is not the case for in line reconstitution syringes which include a certain amount of air after reconstitution and therefore need to be expelled by a nurse before administering). Because the vial during the reconstitution process can be located higher than the cartridge, the vial can work as bubble trap.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

1. A device which automatically reconstitutes a drug, comprising:
a cartridge which contains a liquid capable of reconstituting the drug;
a vial containing the drug;
a connector providing a fluid conduit and to which the vial containing the drug removably inserts, said fluid conduit fluidly couples the cartridge to the vial and defines an entry point where the fluid conduit enters the vial when inserted into the connector;
a cartridge drive mechanically coupled to the cartridge and which changes a pressure of fluid in the cartridge to transfer fluid into or out of the cartridge through the fluid conduit;
a vial drive which adjusts an orientation of the vial; and
a controller electrically coupled to the cartridge drive and the vial drive such that the controller controls transfer of fluid into or out of the cartridge by activating the cartridge drive and controls the orientation of the vial by activating the vial drive.

2. The device of claim 1, wherein the controller:
automatically adjusts the orientation of the vial by activating the vial drive such that the entry point of the vial is gravitationally higher than the drug in the vial;
automatically transfers the liquid out of the cartridge and into the vial with the drug, by activating the cartridge drive, which creates a reconstituted drug,
automatically adjusts the orientation of the vial such that the entry point of the vial is gravitationally lower than the reconstituted drug by activating the vial drive, and
automatically transfers the reconstituted drug out of the vial and into the cartridge by activating the cartridge drive.

3. The device of claim 1, wherein the controller automatically agitates the reconstituted drug in the vial by using the vial drive.

4. The device of claim 1, wherein the controller automatically waits a reconstitution time period after the liquid is transferred out of the cartridge and into the vial with the drug.

5. The device of claim 2, wherein, before the vial is inserted in the connector, the controller orients the connector such that the vial must be inserted in a direction substantially parallel or substantially perpendicular to a direction of gravity.

6. The device of claim 1, further comprising an annunciator electrically coupled to the controller, wherein the controller automatically activates the annunciator after the reconstituted drug is transferred from the vial and into the cartridge.

7. The device of claim 1, wherein the cartridge comprises a rigid vessel and a plunger, wherein:
the fluid conduit is fluidly coupled to the rigid vessel;
the plunger is disposed within the rigid vessel and is movable along a longitudinal axis of the rigid vessel in a first direction and a second direction;
the cartridge drive is mechanically coupled to the plunger and is operable to cause movement of the plunger in the first direction and the second direction; and
the cartridge drive moves the plunger in the first direction to transfer fluid out of the cartridge through the fluid conduit, and the cartridge drive moves the plunger in the second direction to transfer fluid into the cartridge.

8. The device of claim 7 where the rigid vessel is cylindrical in form.

9. The device of claim 7 where the rigid vessel has a noncircular cross-section perpendicular to the longitudinal axis of the rigid vessel.

10. The device of claim 7, wherein the plunger includes two seals between the plunger and a wall of the rigid vessel, and wherein a distance between the two seals is greater than a stroke of the plunger in the first direction and the second direction.

11. The device of claim 7, wherein a stroke of the plunger in the first direction and the second direction is sufficient to transfer all of the fluid in one stroke.

12. The device of claim 7, wherein a stroke of the plunger in the first direction and the second direction is less than a volume of fluid in the cartridge, and a plurality of strokes of the plunger is required to transfer all of the fluid out of the cartridge and to transfer all of the fluid back into the cartridge.

13. The device of claim 7, wherein the cartridge is mechanically coupled to the connector such that adjusting the orientation of the vial causes the cartridge to rotate around a longitudinal axis of the rigid vessel.

14. The device of claim 7, wherein the longitudinal axis of the rigid vessel is about 5 degrees from a plane perpendicular to a direction of gravity and is substantially perpendicular to a longitudinal axis of the vial when inserted into the connector;
a second entry point is defined where the fluid conduit enters the rigid vessel; and
the second entry point is disposed in the rigid vessel such that, when the vial is oriented such that the entry point of the vial is gravitationally lower than a reconstituted drug, the second entry point is gravitationally higher than fluid in the rigid vessel.

15. The device of claim 1, wherein the liquid in the cartridge comprises water for injection.

16. The device of claim 1, wherein the fluid conduit comprises a needle disposed at the connector such that, when the vial is inserted into the connector, the needle is inserted into the vial at the entry point.

17. The device of claim 1, wherein the fluid conduit comprises a needle disposed at the connector such that when the vial is inserted into the connector, the needle is inserted through a septum of the vial to make a fluid connection with the cartridge.

18. The device of claim 1, wherein, when the cartridge is rotated about a longitudinal axis of the cartridge, a seal is broken which creates a fluid connection between the connector and the cartridge.

19. The device of claim 1, wherein the entry point of the vial is disposed in a septum of the vial.

20. The device of claim 1, wherein a longitudinal axis of the cartridge is substantially perpendicular to a direction of gravity.

21. The device of claim 20, wherein a longitudinal axis of the vial is substantially perpendicular to the longitudinal axis of the cartridge.

22. The device of claim 20, wherein the vial drive is operable to adjust the orientation of the vial by axially rotating the vial about the longitudinal axis of the cartridge.

23. The device of claim 20, wherein the vial drive is mechanically coupled to the cartridge, and the vial drive rotates a body of the cartridge about its longitudinal axis, which adjusts the orientation of the vial.

24. The device of claim 1, wherein the vial drive is operable to adjust the orientation of the vial by axially rotating the vial about an axis substantially perpendicular to a direction of gravity.

25. The device of claim 1, wherein a longitudinal axis of the cartridge is substantially parallel to a direction of gravity.

26. The device of claim 25, wherein a longitudinal axis of the vial is substantially parallel to the longitudinal axis of the cartridge.

27. The device of claim 25, wherein the orientation of the vial is adjusted by rotating the vial and the cartridge about an axis substantially perpendicular to the direction of gravity.

28. The device of claim 1, wherein the controller comprises a processor and a memory having computer-readable and computer-executable instructions, and the processor executes the computer-readable and computer-executable instructions to automatically reconstitute the drug.

29. The device of claim 1, wherein a sensor detects when the reconstitution process is completed.

30. A method for automatically reconstituting a drug, the method comprising:
fluidly coupling a vial containing the drug to a cartridge containing a liquid with a fluid conduit, wherein an entry point is defined where the fluid conduit enters the vial;
automatically adjusting an orientation of the vial such that the entry point of the vial is gravitationally higher than the drug in the vial;
automatically transferring the liquid out of the cartridge and into the vial to create a reconstituted drug;
automatically adjusting the orientation of the vial such that the entry point of the vial is gravitationally lower than the reconstituted drug; and
automatically transferring the reconstituted drug from the vial and into the cartridge.

31. The method of claim 30, further comprising automatically agitating the reconstituted drug in the vial.

32. The method of claim 30, further comprising automatically waiting a reconstitution time period after the liquid is transferred out of the cartridge and into the vial with the drug.

33. The method of claims 30, further comprising using a sensor to detect when the reconstitution process is complete.

34. The method of claim 30, wherein a longitudinal axis of the cartridge is substantially perpendicular to a direction of gravity.

35. The method of claim 34, wherein adjusting the orientation of the vial comprises axially rotating the vial about the longitudinal axis of the cartridge.

36. The method of claim 30, further comprising automatically activating an annunciator after transferring the reconstituted drug from the vial and into the cartridge.

37. The method of claim 30, further comprising automatically adjusting the orientation of the vial such that the entry point of the vial is gravitationally higher than a body of the vial after the reconstituted drug has been transferred from the vial into the cartridge to allow a user to fluidly uncouple the vial from the cartridge.

38. A method for automatically reconstituting a drug which comprises utilizing a device of claim 1.
